(19) United States
(12) Patent Application Publication
(10) Pub. No.: US 2002/0108745 A1
(43) Pub. Date: Aug. 15, 2002

(54) Cogeneration system with a heat reservoir

(76) Inventor: Shigeaki Kimura, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/119,944

(22) Filed: Apr. 11, 2002

Related U.S. Application Data
(63) Continuation of application No. 09/487,249, filed on Jan. 19, 2000, now abandoned.

(30) Foreign Application Priority Data
Jan. 19, 1999 (JP) 10889/1999

(51) Int. Cl. B60H 1/02; F24D 1/04; F24D 5/00; F25B 29/00; F24D 11/00; F28D 20/00; F24H 1/00; E01C 19/45

(52) U.S. Cl. 165/236; 165/48.1; 126/343.5 R; 237/12.1

(57) ABSTRACT

A cogeneration system includes an internal combustion engine from which exhaust gases are discharged on combustion of fuel. A waste-heat boiler is connected to the engine to recover waste heat from the exhaust gases and then, heat feedwater to provide hot water. A hot water tank is connected to the boiler and serves as a supply of hot water. An engine cooling system is operatively associated with the engine and has a coolant. The coolant is heated as a result of heat exchange while circulated in the engine. A heat reservoir is connected to the engine cooling system to receive the coolant as heated. Heat in the coolant is accumulated in the body of the heat reservoir and controllably released to warm, for example, a wooden floor.

This is a Continuation Application of U.S. patent application Ser. No. 09/487,249, filed Jan. 19, 2000.

### BACKGROUND OF THE INVENTION

The present invention relates to a cogeneration system particularly suitable for use in residences and small stores.

Those systems that consume energy in residences typically include electric systems, heating systems and hot-water supply systems. Each of these systems requires an independent source of energy. For example, lights and other electric appliances are powered by electricity. A stove, a heater and other heating equipment are operated by electric power, oil or gas. An insulated hot water unit is operated by electric power or gas. The use of various sources of energy is costly. Also, separate and independent control and management of different systems are cumbersome.

There has been proposed a solar system as a home cogeneration system. The solar system replies on solar heat as a sole source of energy and typically includes a solar cell and a solar heater to produce electrical and thermal energy. Such a solar system is economical and easy to maintain, but is unable to constantly provide a sufficient amount of energy, particularly at night or during cloudy days, since it depends solely on solar radiation. The solar system may serve as backup, but should be used in association with other sources of energy.

Accordingly, it is an object of the present invention to provide a cogeneration system particularly suitable for use in residences, which is more economical to operate and easier to control than an existing system, and which is capable of constantly providing a sufficient amount of energy, regardless of the amount of solar irradiation and weather conditions.

### SUMMARY OF THE INVENTION

According to one aspect of the present invention, there is provided a cogeneration system comprising a heat engine, an electric generator driven by the heat engine, a storage battery connected to the electric generator so as to accumulate electricity generated by the electric generator, a source of a relatively cold water, a first heat exchanger connected to the heat engine to recover waste heat so as to heat the cold water, a first heat reservoir fluidly connected to the first heat exchanger to receive the hot water therefrom, a second heat exchanger operatively associated with the heat engine and having a coolant heated as a result of heat exchange while circulated in the heat engine, and a second heat reservoir operatively associated with the second heat exchanger and adapted to receive the coolant as heated and accumulate heat in the coolant.

The heat engine as a single source of energy is capable of serving various loads in an electric system, a heating system and a hot water supply system in a residence. The cogeneration system of the present invention is thus economical to operate and easy to maintain, as opposed to a conventional system where various sources of energy are required to serve those loads. The heat engine may be operated for only a short period of time to serve such loads, for example, four hours a day. This increases the useful service life of the system. Where, for example, a small diesel engine is used as a heat engine and operated constantly four hours a day, no maintenance or overhauling is required for approximately ten years. If, for some reason, the heat engine malfunctions, the heat reservoirs and the storage battery remain operative to provide electric and thermal energy for a certain period of time.

In a preferred mode, the heat engine is an internal combustion engine from which exhaust gases are discharged on combustion of a fuel. The first heat exchanger is a waste-heat boiler designed to recover waste heat from the exhaust gases. The second heat exchanger comprises a water jacket through which the coolant flows, and a combination of a radiator and a fan connected to the water jacket. The radiator and the fan cooperate together to dissipate heat from the coolant after circulated in the heat engine.

The second heat reservoir includes a reservoir body preferably made of concrete. A snow melting system may be connected to the second heat exchanger and constructed to enable contact between the coolant as heated and snow so as to melt snow. Also, a solar cell may be connected to the storage battery and serve as an auxiliary electric power source.

According to another aspect of the present invention, there is provided a cogeneration system comprising a heat engine, an electric generator connected to and driven by the heat engine, a storage battery connected to the electric generator so as to accumulate electricity generated by the electric generator, a source of feedwater, a single heat exchanger connected to the heat engine to recover waste heat so as to heat the feedwater to produce a heating fluid, a first heat reservoir fluidly connected to the heat exchanger to receive part of the heating fluid therefrom, and a second heat reservoir fluidly connected to the heat exchanger to receive part of the heating fluid therefrom.

In a preferred mode, the heat engine is a gas turbine. The gas turbine is more compact than an internal combustion engine such as a diesel engine and requires only a relatively small floor space to install. Also, the level of noise and vibration is less in the gas turbine than the internal combustion engine. In the gas turbine, 25 to 30% of the energy in fuel is converted to mechanical energy, as compared to 35% of the energy in the case of a typical internal combustion engine. On the other hand, the gas turbine emits significantly high temperature exhaust gases and is thus capable of recover more waste heat than the internal combustion engine.

A solar cell may be connected to the storage battery and serves as an auxiliary electric power source. Advantageously, the solar cell can serve electrical loads in a single year-round air conditioning system and electrical appliances, where total electrical loads are high, typically during the summer and winter months. Additionally, the solar cell serves as an auxiliary source of energy in the event that the heat engine or turbine is out of order.

Further, a snow melting system may be connected to the heat engine, the solar cell, the first heat reservoir and/or the second heat reservoir to collect heat to melt snow. Various snow melting systems have heretofore been proposed, but most of them do not prevail due to their high running costs. The snow melting system of the present invention can be operated at a relatively low cost since it can be driven by exhaust gas heat as recovered.

### BRIEF DESCRIPTION OF THE DRAWINGS

FIG. 1 is a schematic diagram of a cogeneration system according to one embodiment of the present invention; and

FIG. 2 is a schematic diagram of a cogeneration system according to another embodiment of the present invention.

### DESCRIPTION OF THE PREFERRED EMBODIMENTS

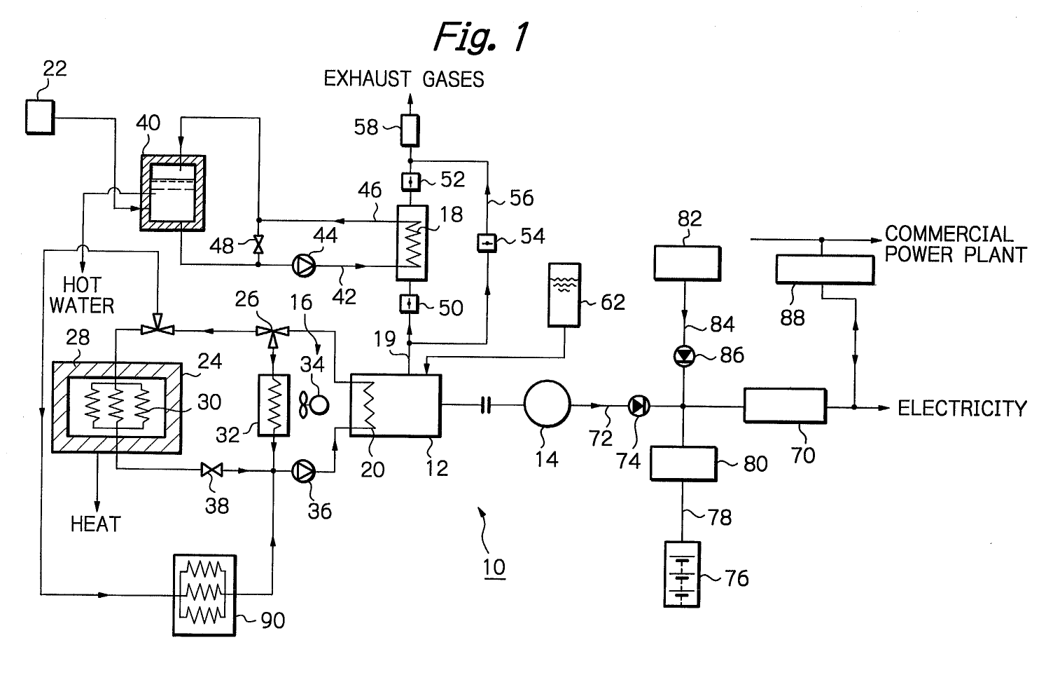

Referring first to FIG. 1, there is shown a cogeneration system made according to one embodiment of the present invention and generally designated at 10. The cogeneration system 10 includes a compact internal combustion engine 12 as a prime mover. The internal combustion engine 12 may be a diesel engine, a gasoline engine, a gas engine and other heat engines.

The cogeneration system 10 also includes an electric generator 14 driven by the engine 12, and an engine cooling system 16 operatively associated with the engine 12, and a waste-heat boiler 18 connected to the engine 12 though a line 19. The cooling system 16 includes a water jacket 20 through which a stream of coolant passes to prevent overheating of the engine 12. The coolant is heated as a result of heat exchange while it is circulated in the engine 12. The boiler 18 is connected to a source 22 of feedwater. The boiler 18 receives exhaust gases from the engine 12 and is operable to recover exhaust gas heat. This heat is used to heat the feedwater or cold water so as to produce a relatively high temperature hot water.

In a typical small internal combustion engine, approximately 35% of the energy contained in a fuel is converted to mechanical work, but the remaining energy is wastefully discarded. In the cogeneration system 10 shown in FIG. 1, a substantial part of such waste heat can advantageously be recovered as a heating medium by the cooling system 16 and the boiler 18.

After the coolant is heated, the resulting hot water is fed to a heat accumulator or reservoir 24 via a valve 26. The heat reservoir 24 includes a reservoir body 28 in which a plurality of heat pipes 30 are embedded in a heat exchange relationship. Illustratively, the body 28 is made of concrete. Although the body 28 may be in the form of a stone bed, a ballast bed or a soil bed, or a water tank, it is preferable to use concrete for a few reasons. Firstly, concrete is capable of accumulating more heat than most of other materials and has a heat capacity 1,600 times greater than that of air. Secondly, the concrete heat reservoir 24 can be economically manufactured by simply inserting a plurality of heat pipes before a base is cast in concrete. Such an integral arrangement is highly reliable as a heat storage and is also rigid so that loads may be effectively dispersed.

The coolant, after heated in the engine 12, is caused to flow through the heat pipes 30. Heat in the coolant is then transferred to and accumulated in the reservoir body 28. The heat is controllably released from the reservoir body 28 so as to warm, for example, a wooden floor (not shown) under which the heat reservoir 28 is placed. In a relatively warm area such as Tokyo and Washington, D.C., such a wooden floor can be maintained in a warm condition by operating the internal combustion engine 12 for, for example, a total of four hours a day, typically two hours in the morning and two hours in the evening. The time during which the coolant or hot water is required to flow through the heat pipes 30 depends on outside temperatures of the area served.

When no accumulation of heat is required, the valve 26 is so actuated as to disconnect the heat reservoir 24 from the water jacket 20 and instead, connect the water jacket 20 to a radiator 32. The radiator 32 is operatively associated with a fan 34 so as to cool the heated coolant. A pump 36 is connected between the radiator 32 and the water jacket 20 so as to feed the coolant as cooled to the water jacket 20. The radiator 32, the fan 34 and the pump 36 form part of the engine cooling system 16. A check valve 38 is provided to prevent the flow of the coolant from the radiator 32 to the heat reservoir 24.

An insulated heat reservoir or hot water tank 40 is connected to the feedwater source 22 and serves as a supply of hot water. The heat reservoir 40 is also connected to the boiler 18 through a line 42. A feedwater pump 44 is provided in the line 42 to feed the feedwater to the boiler 18. The feedwater is heated in the boiler 18 by the application of heat in exhaust gases from the internal combustion engine 12. The feedwater as heated is then fed to the heat reservoir 40 through a line 46. A safety valve 48 is connected between the lines 42 and 46.

Typically, an existing electrically operated hot water supply system is operated once a day, only during nighttime at which time there is substantially no demand for hot water, since electricity can be used at economical rates. Thus, such an existing system requires a large tank to contain a large volume of hot water at a time. According to the present invention, the internal combustion engine 12 may be operated twice a day, typically, during morning and evening at which time the consumption of hot water is maximized. This makes it possible to reduce the volume of the heat reservoir or tank 40 to one half of that of the existing tank. Other advantages of the heat reservoir 40 include less space requirement and reduced installation costs.

Referring still to FIG. 1, two dampers 50, 52 are provided in the line 19 at locations downstream and upstream of the boiler 18, respectively. Also, a damper 54 is provided in a bypass line 56 which is, in turn, joined to the line 19 at points upstream and downstream of the boiler 18. When no recovery of exhaust gas heat is required, or when the heat reservoir 40 becomes substantially filled with hot water, all of the dampers 50, 52, 54 are so actuated as to cause exhaust gases to flow from the engine 12 to the bypass line 56 rather than to the boiler 18. A muffler 58 is connected to the downstream end of the line 19 so as to reduce noise which may arise when the exhaust gases are discharged to ambient atmosphere.

A suitable fuel tank 62 is connected to the internal combustion engine 12. Combustion of a fuel takes place in the engine 12 to produce mechanical energy or shaft power by which the electric generator 14 is driven to produce electric power or electricity. The electric generator 14 is connected to an inverter 70 through a line 72. A diode 74 is provided in the line 72 between the electric generator 14 and the inverter 70 to prevent the flow of electrical current from the inverter 70 toward the electric generator 14. The inverter 70 converts direct current into alternating current before electricity is supplied. A storage battery 76 is connected to the line 72 through a line 78. A controller 80 is provided in the line 78. When electricity is generated significantly more than required, part of the electricity is accumulated in the storage battery 76. The storage battery 76 is operable to release the electricity as demanded when the internal combustion engine 12 is held in an inoperative state. This electricity is then fed through the controller 80 to the inverter 70.

Advantageously, the system may be designed to supply an alternating current of 200 volts (220 volts in the United States) rather than 100 volts. In such a case, a kitchen stove for residential use, which uses a substantial amount of energy, may be operated by electric power rather than gas. optionally, a solar cell 82 may be connected to the line 72 through a line 84 to feed auxiliary electricity. This auxiliary electricity may be used to operate, for example, an air-conditioning system particularly during summer and winter. A diode 86 is provided in the line 84 to prevent the flow of electric current from the line 72 toward the solar cell 82. The line 84 is connected to the line 78 so that the electricity generated by the solar cell 82 is fed to the storage battery 76 when necessary. The solar cell 82 may be activated when the internal combustion engine 12 is held in an inoperative state or malfunctions. If desired, a suitable transmission system 88 may be connected to the line 72 so as to transmit excess electric energy to commercial power plants (not shown). The transmission system 88 may be designed to receive electricity from such commercial power plants in the event that the cogeneration system 10 is out of order.

A snow melting system 90 may be associated with the engine cooling system 16. Illustratively, the snow melting system 90 receives hot water from the water jacket 20 after coolant is heated in the engine 12. Heat in the hot water is released so as to melt snow. The snow melting system 90 may be operatively associated with the solar cell 82.

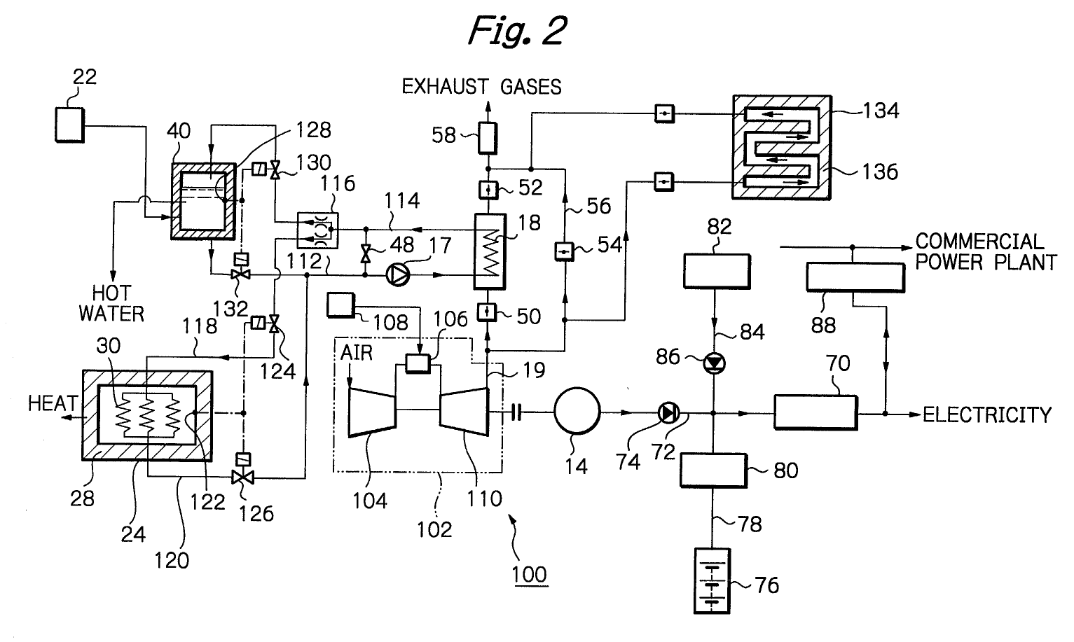

Referring next to FIG. 2, there is shown a cogeneration system made according to another embodiment of the present invention and generally designated at 100. Like elements are given like reference numerals used in FIG. 1. Basically, this embodiment is different from the previous embodiment in that heat is all recovered from exhaust gases.

As shown in FIG. 2, the cogeneration system 100 includes a heat engine or gas turbine. The gas turbine 102 generally includes a compressor 104 for providing compressed air, a combustion chamber 106 wherein fuel from a source 108 of fuel is mixed with the compressed air for combustion, and a turbine body 110 for converting kinetic energy into mechanical energy and delivering the mechanical energy through a rotating shaft (not shown). The electric generator 14 is driven for rotation by the rotating shaft of the turbine body 110. The electric generator 14 and its associated electrical components are identical to those shown in FIG. 1 and will not be described herein.

The gas turbine 102 is connected to the boiler 18 through the line 19 so that waste heat in the exhaust gases from the gas turbine 102 is recovered by the boiler 18. The boiler 18 is connected to the heat reservoir 40 through a line 112. As in the previous embodiment, the feedwater pump 17 is provided in the line 112 to feed feedwater to the boiler 18. The feedwater is heated by the application of heat recovered from the exhaust gases. Part of the heated water is then fed from the boiler 18 to the heat reservoir 40 through a line 114. A distribution valve 116 is arranged in the line 114 to feed part of the heated water to the insulated heat reservoir 24 through a line 118. A line 120 extends between the heat reservoir 24 and the line 112. A thermal switch 122 is operatively associated with the heat reservoir 24. Two valves 124, 126 are arranged in the respective lines 118, 120. The thermal switch 122 is operable to close the valves 124, 126 so as to interrupt flow of the hot water to and from the heat reservoir 24 when the amount of heat built up in the heat reservoir 24 reaches a required value. The valves 124, 126 can be manually closed when no heating is necessary, for example, in summers.

Also, a thermal switch 128 is operatively associated with the heat reservoir 40. Two valves 130, 132 are arranged in the respective lines 114, 112. When the heat reservoir 40 becomes substantially filled with hot water, the thermal switch 128 is rendered operative to close the valves 130, 132. At this time, the feedwater pump 17 is rendered inoperative if the valves 124, 126 are closed. The valve 48 serves as a safety valve where a delay occurs when the feedwater pump 17 is stopped.

Heat in exhaust gases from the gas turbine 100 is significantly high in temperature, so that the boiler 18 may produce steam instead of hot water. In such a case, steam is fed to the heat reservoir 24 so that heat is built up in the reservoir body 28 as a result of heat exchange. Also, the feedwater from the feedwater source 22 can be heated directly by the steam so as to produce a relatively high temperature hot water.

Optionally, a snow melting system 134 may be connected to the gas turbine 100. The snow melting system 134 includes a heat reservoir body 136 wherein heat in the exhaust gases from the gas turbine 100 is accumulated. This heat is released from the body 136 to melt snow. Although not shown, the body 136 may alternatively be connected to the electric generator 14 or the solar cell 28 so that the body 136 may be electrically heated. Still alternatively, the body 136 may be connected to the boiler 18 so that the body 36 may be heated by hot water.

While the invention has been described in connection with certain preferred embodiments, it will be understood that it is not intended to limit the invention to those particular embodiments. On the contrary, it is intended to cover all alternatives, modifications and equivalent arrangements as may be included within the spirit and scope of the invention as defined by the appended claims.

What is claimed is:

1. A cogeneration system comprising:
a heat engine;
an electric generator driven by said heat engine;
a storage battery connected to said electric generator so as to accumulate electricity generated by said electric generator;
a source of a relatively cold water;
a first heat exchanger connected to said heat engine so as to recover waste heat therefrom, said first heat exchanger being connected to said source of cold water and constructed to heat the cold water to provide a relatively hot water;
a first heat reservoir fluidly connected to said first heat exchanger to receive the hot water therefrom;
a second heat exchanger operatively associated with said heat engine, said second heat exchanger having a coolant heated as a result of heat exchange while circulated in said heat engine; and
a second heat reservoir operatively associated with said second heat exchanger, said second heat reservoir being adapted to receive the coolant as heated and accumulate heat in the coolant.

2. The system of claim 1, wherein said heat engine is an internal combustion engine from which exhaust gases are discharged on combustion of a fuel, and said first heat exchanger is a waste-heat boiler designed to recover the waste heat from the exhaust gases.

3. The system of claim 1, wherein said second heat exchanger comprises a water jacket through which the coolant flows, and a combination of a radiator and a fan connected to said water jacket, said radiator and said fan cooperating together to dissipate heat from the coolant after circulated in said heat engine.

4. The system of claim 1, wherein said second heat reservoir includes a reservoir body made of concrete.

5. The system of claim 1, further comprising a snow melting system connected to said second heat exchanger and constructed to enable contact between the coolant as heated and snow.

6. The system of claim 1, further comprising a solar cell connected to said storage battery.

7. A cogeneration system comprising:
a heat engine;
an electric generator connected to and driven by said heat engine;
a storage battery connected to said electric generator so as to accumulate electricity generated by said electric generator;
a source of feedwater;
a single heat exchanger connected to said heat engine to recover waste heat therefrom, said heat exchanger being connected to said source of feedwater and constructed to heat the feedwater to produce a heating fluid;
a first heat reservoir fluidly connected to said heat exchanger to receive part of the heating fluid therefrom; and
a second heat reservoir fluidly connected to said heat exchanger to receive part of the heating fluid therefrom.

8. The system of claim 7, wherein said heat engine is a gas turbine.

9. The system of claim 7, wherein the heating fluid is in the form of hot water.

10. The system of claim 7, wherein the heating fluid is in the form of steam.

11. The system of claim 7, wherein said second heat reservoir includes a reservoir body made of concrete.

12. The system of claim 7, further comprising a solar cell connected to said storage battery.

13. The system of claim 7, further comprising a snow melting system connected to said heat engine and constructed to recover waste heat therefrom.
